(19) United States
(12) Patent Application Publication
(10) Pub. No.: US 2011/0040757 A1
(43) Pub. Date: Feb. 17, 2011

(54) METHOD AND APPARATUS FOR ENHANCING OBJECTS WITH TAG-BASED CONTENT

(75) Inventors: Jouni KOSSI, Espoo (FI); Jari-Jukka KAAJA, Jarvenpaa (FI); Jarmo ARPONEN, Espoo (FI)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/541,543

(22) Filed: Aug. 14, 2009

(51) Int. Cl. G06F 17/30

(52) U.S. Cl. 707/737; 707/E17.055; 707/770

(57) ABSTRACT

An approach is provided for enhancing objects with tag-based content. One or more memory tags associated with one or more objects are detected within proximity of a mobile device. The memory tag contains supplemental information related to the one or more objects. One of the detected memory tags is selected by receiving an input signal or by applying one or more selection criteria. Selection of one of the detected memory tags initiates reading of the supplemental information from the selected memory tag. The supplemental information includes recognition information to associate the supplemental information with a specific section or portion of a respective one of the objects.

### BACKGROUND

Wireless (e.g., cellular) service providers and device manufacturers are continually challenged to deliver value and convenience to consumers by, for example, providing compelling services, applications, and content. One area of development is the integration of digital information and services with tangible objects (e.g., printed media, clothing, products, etc.) and their delivery channels (e.g., mail delivery, kiosks, stores, etc.). Historically, producers and manufacturers of tangible objects have not taken direct advantage of the growing availability of digital information. However, with the development of low-cost radio frequency (RF) memory tags that can be associated with any object, direct links between a tagged object and digital information can be created. Therefore, there is a need for an approach to efficiently and quickly detect RF memory tags (e.g., high memory capacity near field communication (NFC) tags or other wirelessly powered memory tags) associated with objects and enable user interaction between the tagged object and related digital information.

### SOME EXAMPLE EMBODIMENTS

According to one embodiment, a method comprises detecting one or more memory tags associated with one or more objects within proximity of a mobile device. The memory tag contains supplemental information related to the one or more objects. The method also comprises selecting one of the detected memory tags by receiving an input signal or by applying one or more selection criteria. The method further comprises initiating reading of the supplemental information from the selected memory tag, wherein the supplemental information includes recognition information to associate the supplemental information with a specific section or portion of a respective one of the objects.

According to another embodiment, an apparatus comprising at least one processor, and at least one memory including computer program code, that at least one memory and the computer program code configured to, with the at least one processor, cause the apparatus to detect one or more memory tags associated with one or more objects within proximity of a mobile device. The memory tag contains supplemental information related to the one or more objects. The apparatus is also caused to select one of the detected memory tags by receiving an input signal or by applying one or more selection criteria. The method is further caused to initiate reading of the supplemental information from the selected memory tag, wherein the supplemental information includes recognition information to associate the supplemental information with a specific section of a respective one of the objects.

According to another embodiment, a computer-readable storage medium carrying one or more sequences of one or more instructions which, when executed by one or more processors, cause an apparatus to detect one or more memory tags associated with one or more objects within proximity of a mobile device. The memory tag contains supplemental information related to the one or more objects. The apparatus is also caused to select one of the detected memory tags by receiving an input signal or by applying one or more selection criteria. The method is further caused to initiate reading of the supplemental information from the selected memory tag, wherein the supplemental information includes recognition information to associate the supplemental information with a specific section of a respective one of the objects.

According to yet another embodiment, an apparatus comprises means for detecting one or more memory tags associated with one or more objects within proximity of a mobile device. The memory tag contains supplemental information related to the one or more objects. The apparatus also comprises means for selecting one of the detected memory tags by receiving an input signal or by applying one or more selection criteria. The apparatus further comprises means for initiating reading of the supplemental information from the selected memory tag, wherein the supplemental information includes recognition information to associate the supplemental information with a specific section or portion of a respective one of the objects.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a communication system capable of enhancing objects with tag-based content, according to one embodiment;

FIGS. 2A and 2B are, respectively, diagrams of components of a tag-based content module and diagrams of components of a services platform, according to various embodiments;

FIGS. 3A and 3B are flowcharts of a process for enhancing objects with tag-based content, according to one embodiment;

FIG. 4 is a flowchart of a process for accessing tag-based content using a memory tag associated with an object, according to one embodiment;

FIGS. 5A-5D are diagrams of user interfaces utilized in the processes of FIGS. 3A-3B and FIG. 4, according to various embodiments;

FIG. 6 is a diagram of communication system capable of supporting updatable memory tags, according to one embodiment;

FIG. 7 is a flowchart of a process for detecting and verifying setup of an updatable memory tag, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile station (e.g., handset) that can be used to implement an embodiment of the invention.

### DESCRIPTION OF SOME EMBODIMENTS

A method and apparatus for enhancing objects with tag-based content are disclosed. As used herein, the term “objects” refers to any object that can be associated with an electronic memory tag including printed media (e.g., books, magazines, newspapers, catalogs, advertisements, billboards, and the like), clothing, products, household items, electronic devices, etc. Additionally, the term “tag-based content” includes any information that is stored a electronic memory tag such as a high memory capacity near field communication (NFC) tag (e.g., a radio frequency identification (RFID) tag, contactless card, and the like) or other wirelessly powered memory tag. It is contemplated that the information stored in the memory tag may specify content and/or actions to be performed.

In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

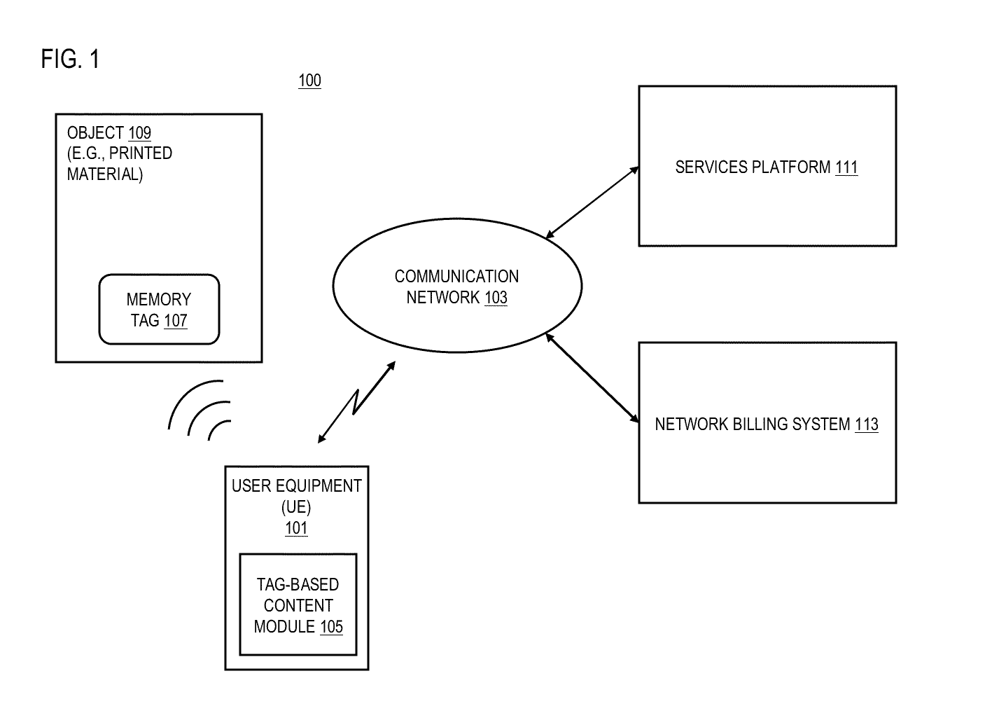

FIG. 1 is a diagram of a communication system capable of enhancing objects with tag-based content, according to one embodiment. Historically, tangible objects (e.g., products, printed media, etc.) have well established means of distribution (e.g., stores, kiosks, etc.) that extend beyond the reach of electronic information transmitted over public networks (e.g., the Internet, telephone systems). For example, printed media have been the most widely used and distributed form of information because they are easy to use and produce. However, for the most part, printed media and other objects have missed being integrated into the digital information revolution. Many printed media (e.g., newspapers, magazines, books, etc.) have been digitized or otherwise made available in digital form, but the original printed media still provide no easy way for a user to link directly from the printed media to related digital content. For example, a user who reads an article in a printed magazine or picks up an object cannot directly search for more information about that article or object on the Internet, view a video related to article or article, or access any other related digital information or content. Instead, the user has to manually search for the information when the user is online or when an Internet connection is available.

The system 100 of FIG. 1 addresses this problem by associating a memory tag to objects such as the printed media. By way of example, the memory tag has sufficient memory to store supplemental information (e.g., text, video, still pictures, voice media, web links, databases, videos, documents, software, purchasing information, etc.) about its associated object. In one embodiment, a user device (e.g., a mobile telephone equipped with a tag reader and/or writer) detects the memory tag associated with an object, reads the supplemental information from the memory tag, correlate sections of the printed media to the supplemental information based on a recognition engine (e.g., optical pattern recognition, audio recognition, voice recognition, etc.), and enables the user to interact with specific sections or portions of the object based on the correlated supplemental information and user preferences.

For example, a user is reading a printed catalog that includes an associated memory tag. The user detects the memory tag with a mobile device and reads the supplemental information from the memory tag. As the user pages through the catalog, the user's mobile device automatically captures images of the printed media or sections of the printed media using the mobile device's on-board camera, the mobile device recognizes sections of the printed media corresponding to, for instance, particular items available for purchase. On recognizing the items, the mobile device provides the user with options to perform various actions such as view additional related content available in the memory tag, to initiate purchase of an item via the mobile device, or to access services available in the system 100. As used herein, the term “services” includes services, applications, content, or any combination thereof. In this way, the system 100 enables the seamless integration of the media with related digital content and actions. In certain embodiments, the mobile device presents the supplemental information and enables user interaction with the information according to user-specified preferences. For example, a user profile may specify what types of information to present (e.g., a first user specifies that the user is interested only in pricing information whereas another user specifies an interest only in seeing technical information).

As shown in FIG. 1, a system 100 comprises a user equipment (UE) 101 having connectivity to a communication network 103. The UE 101 is any type of fixed terminal, mobile terminal, or portable terminal including desktop computers, laptop computers, handsets, stations, units, devices, multimedia tablets, Internet nodes, communicators, Personal Digital Assistants (PDAs), mobile phones, mobile communication devices, digital camera/camcorders, audio/video players, positioning devices, game devices, televisions, and/or the like, or any combination thereof. It is also contemplated that the UE 101 can support any type of interface to the user (such as “wearable” circuitry, etc.) and includes a memory tag reader, a camera, or other similar input/output (IO) component. The UE 101 includes a tag-based content module 105 to enable interaction with a memory tag 107 associated with an object 109 (e.g., printed media) as described herein.

In example embodiments, the memory tag 107 is a near field communication (NFC) tag, radio frequency identification (RFID) tag, contactless card, a wirelessly powered memory tag, or the like that includes sufficient memory to store information related to the object 109. The memory tag 107, for instance, is associated (e.g. embedded in, attached to, or printed on) any of a variety of objects capable of supporting the tag (e.g., packaging material, a sticker, a poster, a card, a magazine, a newspaper, products, clothing etc.). For example, a memory tag 107 associated with a piece of clothing may provide laundry instructions or links to local dry cleaners. In one embodiment, the memory tag 107 is a high memory capacity NFC tag that contains several gigabits of memory with fast access and download times. It is contemplated that the memory tag 107 may also be any similar wirelessly powered memory tag.

By way of example, NFC, RFID, contactless card, and similar technologies are short-range wireless communication technologies that enable the exchange (e.g., both reading and writing) of data between devices and tags over short distances (e.g., the range for NFC is approximately 4 inches). In general, these technologies comprise two main components, a tag (e.g., attached to an object) and a reader/writer (which can be implemented within the UE 101). Communication between the reader/writer and the tags occur wirelessly and may not require a line of sight between the devices. The tag (e.g., an RFID transponder) is, for instance, a small microchip that is attached to an antenna. The tags can vary in sizes, shapes, and forms and can be read through many types of materials. Moreover, the tags may be passive tags or active tags. Passive tags are generally smaller, lighter, and less expensive than active tags. Passive tags are only activated when with the response range of a reader/writer. In other words, passive tags are typically memory tags that are wirelessly powered by the reader/writer. The reader/writer emits a low-power radio wave field that is used to power the tag so as to pass on any information that is contained on the chip. Active tags differ in that they incorporate their own power source to transmit rather than reflect radio frequency signals. Accordingly, active tags enable a broader range of functionality like programmable and read/write capabilities. The read/write capabilities of the memory tag 107 can, for instance, enable the system 100 to write comments for storage in the memory tag 107 for retrieval by other users or update the content of the memory tag 107 to include the latest content. For example, a memory tag 107 associated an advertisement can be updated to contain the latest pricing and availability information.

A reader/writer typically contains a transmitter, receiver, control unit, and an antenna. The reader/writer performs several primary functions: energizing the tag, demodulating and decoding the returned radio signal, and providing clock information. In certain embodiments, a reader/writer includes an additional interface to convert the returned radio signal to a form that can be passed to another system such as a computer or programmable logic controller.

As discussed previously, the memory tag 107 contains supplemental information regarding the object 109 including text, videos, pictures, audio files, databases, documents, software, and the like. In certain embodiments, the supplemental information also includes recognition information that can be used by the UE 101 to correlate sections of the corresponding object with the supplemental information. The recognition information can include information to support optical recognition (e.g., recognizing images or patterns of or presented by an associated object), audio recognition (e.g., recognizing specific sounds of an associated object), voice recognition (e.g., recognizing speech from an associated object). The recognition information enables the tag-based content module 105 to correlate individual pieces of the supplemental information with the appropriate section or portion of the object 109 based on a recognition engine. It is contemplated that the object 109 may contain multiple passive and/or active memory tags 107, for instance, when one memory tag 107 does not have sufficient memory capacity to store the supplemental information for the printed media, or when the producer or manufacturer of the object 109 wants to organize the sections or portion of the object 109 according to multiple memory tags 107.

In certain embodiments, the memory tag 107 may require specific access codes before allowing the UE 101 to read the supplemental information from the memory tag 107. In one embodiment, the code may be checked automatically through, for instance, the services platform 111. In this way, the contents of the memory tag 107 may be restricted only to authorized users. For example, a tag-enabled magazine may restrict access to supplemental information to subscribers only by requiring an access code. Subscribers would be provided with the proper access code to access the memory tag 107; other users would not have access. The provided access code may be stored in a user profile or the service platform 111 for automatic retrieval and use. Under this scenario, all users have access to the printed media 109 but only subscribers would have access to supplemental digital information.

By way of example, the communication network 103 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), wireless personal area network (WPAN), short range radio networks, and the like.

As shown in FIG. 1, the UE 101 has connectivity to a services platform 111, such as OVI.com and OVI Store, and a network billing system 113 through the communication network 103. It is contemplated that the services platform 111 and a network billing system 113 may be operated on the same platform or service. In exemplary embodiments, the services platform 111 provides services to support actions that may be related to the supplemental information contained in the memory tag 107 (e.g., providing access codes to the memory tag 107, registering a user, purchasing items, downloading software, etc.). In certain embodiments, the services platform 11 also interacts with the network billing system 113 to coordinate payment and billing for the services. The network billing system 113 is owned or served by, for instance, a service provider (e.g., cellular service provider) through which the user of the UE 101 has communication (e.g., wireless) service. Accordingly, the user of the UE 101 generally already has a billing relationship with the network billing system 113 and the associated service provider. It is contemplated that the network billing system 113 may also be owned by third party such as third party payment providers, like credit card service providers, banks, etc.

By way of example, the UE 101 communicates with the other devices or components (e.g., the services platform 111) on the communication network 103 using standard protocols. In this context, a protocol includes a set of rules defining how the network nodes within the communication network 103 (e.g., UE 101 and services platform 111) interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination/address, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

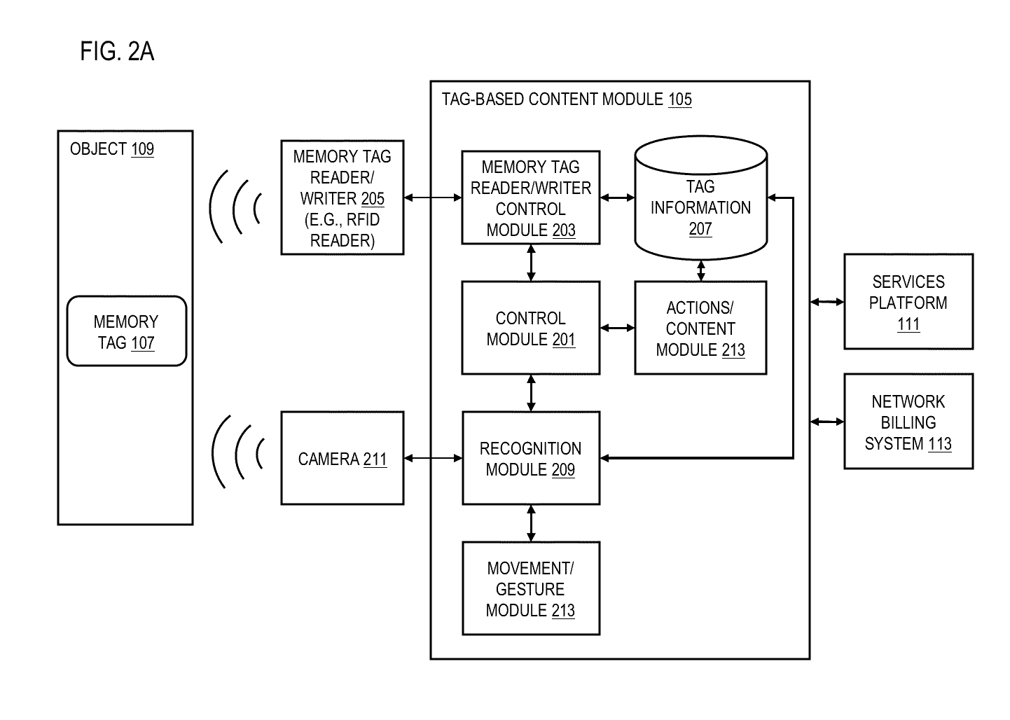

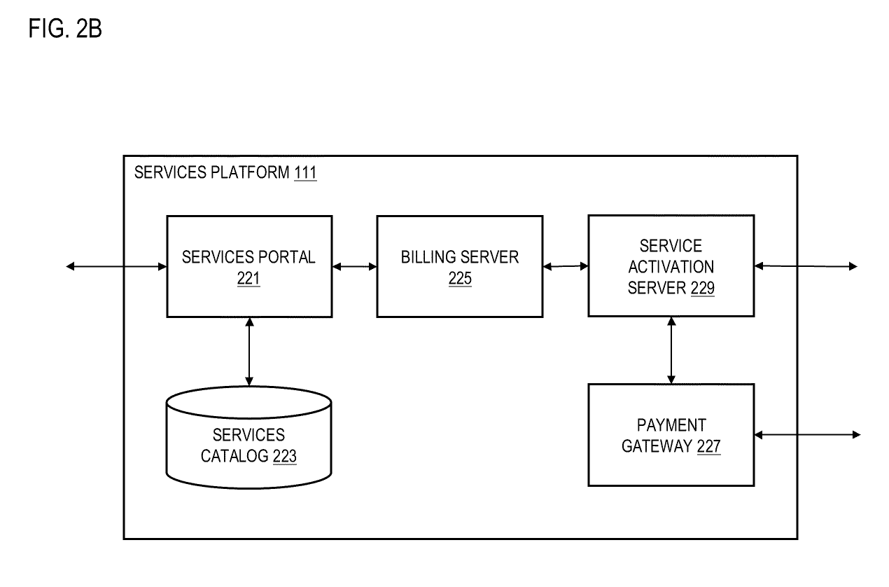

FIGS. 2A and 2B are diagrams of components of a tag-based content module and components of a services platform respectively, according to various embodiments. As shown in FIG. 2A, the tag-based content module 105 includes several sub-modules to enhance the object 109 with supplemental information from the memory tag 107. It is contemplated that the functions of the sub-modules may be combined or performed by other components or logic of the UE 101. In exemplary embodiments, the tag-based content module 105 includes a control module 201 for directing interaction with the memory tag 107 for obtaining supplemental information related to the object 109. The module 201 may, for instance, interact with a memory tag reader/writer control module 203 to detect user input for selecting the memory tag 107 in the printed media 109. By way of example, the user input may be indicated by tapping the UE 101 one or more times on or near the memory tag 107. The number of taps to initiate a request is configurable by the user, the service provider, or both. It is also contemplated that tapping includes bringing the UE 101 at least sufficiently close enough to the memory tag 107 so that the UE 101 can detect a return signal from the memory tag 107. A physical tap is not necessary. In addition or alternatively, the user can signal a request to select and read the memory tag 107 by activating one or more buttons or menu options on the UE 101, by otherwise causing the UE 101 to read the memory tag 107, or by any combination thereof.

After detecting the selection of the memory tag 107, the control module 201, for example, causes the memory tag reader/writer control module 203 to interact with an external memory tag reader/writer 205 (e.g., RFID reader/writer, NFC reader/writer, etc.). More specifically, the module 203, for instance, initiates the reader/writer 205 to download the supplemental information contained in the memory tag 107. In certain embodiments, the memory tag reader/writer is a component of the UE 101 (e.g., a handset with a built-in reader) in which the tag-based content module 105 resides. In other embodiments, the reader/writer 205 may be an external peripheral attached to the UE 101. Additionally, in cases where the memory tag 107 requires an access code, the control module 201 can provide the access code or request that the user enter the access code before initiating reading of the memory tag 107. In one embodiment, the services platform 111 can provide the access code to the control module 201 automatically. The memory tag reader/writer control module 203 stores the read supplemental information in the tag information database 207. In one embodiment, the supplemental information includes recognition information to associate the supplemental information with a specific section or portion of the object 109. The supplemental information may also include an electronic representation of the object 109 (e.g., an electronic version of a hardcopy magazine or catalog), one or more media files, one or more documents, one or more links to content, purchasing information, advertising information, an electronic catalog, or a combination thereof. If the memory tag 107 has write capabilities, the memory tag reader/writer control module 203 can direct the reader/writer 205 to write new information to the memory tag 107 including, e.g., writing comments by the user regarding the object 109 or updating the supplemental information stored in the memory tag 109. For example, the reader/writer 205 can write a user's review or notes on an item in tagged catalog for later reference. In another example, the reader/writer 205 can write a comment noting the last date that a coat associated with a memory tag 107 has been cleaned.

On successfully reading the memory tag 107, the control module 201 directs the recognition module 209 to activate the camera 211 to begin capturing images of the printed media 109. By way of example, the camera 211 may capture a live streaming image of the printed media 109 or may capture individual images at predetermined time intervals (e.g., every second or every 5 seconds). As the images are captured, the recognition module 209, for instance, retrieves recognition information (e.g., stored patterns or images) from the supplemental information stored in the tag information database 207 for comparison against the captured images of the object 109. For example, the recognition module 209 uses optical recognition to match the images of the object 109 against the stored recognition information. In one embodiment, the matching process attempts to correlated sections of the captured image against reference images stored in the recognition information in the database 207. In other embodiments, the recognition module 209 may also perform audio or speech recognition on the object 109.

If a recognition match is found, the recognition module 209 initiates highlighting of the one or more recognized sections or portions of the object 109. The highlight may include, for instance, placing a rectangle around the recognized section. It is contemplated that the recognition module 209 may use any highlighting mechanism to distinguish the recognized section of the object 109 from the unrecognized sections. By way of example, highlighting mechanism may include visual highlighting, audio alerts, and/or vibration or haptic feedback. The control module 201 then detects an input signal for selecting one of the highlighted sections. In one embodiment, the input signal may be initiated by touching the corresponding section of the display on the UE 101, actuating one or more keys on the mobile device, moving a cursor to the corresponding section of the display, or some other similar mechanism. Based on the detection, the control module 201 directs the actions/content module 213 to retrieve the actions and/or content corresponding to the selected section and to present a menu of one or more actions or content related to the selected section. In addition or alternatively, the control module 201 may direct the actions/content module 213 to present a menu of one or more actions related to each of the recognized sections or portions of the object 109 rather than just the selected section.

The control module 201 then waits detect an input signal for selecting one of the actions or content presented in the menu. In one embodiment, the input signal is initiated by a directional movement of the mobile device or by movement of the mobile device in a predefined pattern or gesture. By way of example, the movement may be detected by analyzing movement of the images captured by the camera of the mobile device. In addition or alternatively, the movement may be detected by an accelerometer, radar technology, or another similar movement sensor. The control module 201 can, for instance, initiate display of direction or sequence of movement for initiating a particular action or content. Based on the detection, the module 201 initiates the selected action or delivery of the selected content. In one embodiment, the control module 201 interacts with the services platform 111 and/or the network billing system 113 to initiate the action or deliver the content.

FIG. 2B is a diagram of the components of a services platform, according to an exemplary embodiment. As shown in FIG. 2B, the services platform 111 includes several components to support actions or content initiated by the tag-based content module 105 based on the supplemental information read from the memory tag 107. It is contemplated that the functions of the components may be combined or performed by other components within the platform 111. In exemplary embodiments, the services platform 111 includes a services portal (e.g., store front) 221 for receiving service requests and delivering services to the UE 101. The services portal 221 has connectivity to services catalog database 223 containing information to identify the services that are appropriate for performing the actions or delivering the content requested by the tag-based content module 105. On receipt of a request for service, the services portal 221 interacts with the database 223 and billing system (e.g., server) 225 to determine user information (e.g., user identity, user profile, etc.) and/or the billing information (e.g., monthly fee, discounts, promotions, product cost, credit card number, bank account, credit point, etc.) associated with the received service request. In one embodiment, the services portal 221 uses the billing information to generate a message requesting confirmation of the service management request from the user.

On receipt of the user confirmation, the services portal 221, for example, directs the payment gateway 227 to collect the fees associated with the request. In exemplary embodiments, the payment gateway 227 may interact with the network billing system 113 to collect payment using, for example: (1) direct billing to the user using the International Mobile Station Identity (IMSI) associated with the user's UE 101, wherein the user's phone bill is directly charged for any fees and the payment gateway 227 makes a billing request to the network billing system 113 to recover the fees based on the IMSI; (2) direct billing using a 3G/GPRS access point, wherein the user's phone bill is directly charged for any fees and the payment gateway 227 makes a billing request to the network billing system 113 to recover the fees based the network assigned ID (e.g., a Mobile Subscriber Integrated Digital Services Network (MSISDN) number); (3) direct billing using a wireless access protocol (WAP) access point, wherein the user's phone bill is directly charged for any fees and the payment gateway 227 makes a billing request to the network billing system 113 to recover the fees based the network assigned ID (e.g., MSISDN) (i.e., WAP direct billing); (4) direct billing using WAP, wherein the user accesses a WAP portal to authorize payment against the user's phone bill and the payment gateway 227 makes a billing request to the network billing system 113 to recover the fees (i.e., WAP online billing); (5) direct billing using premium short message service (SMS) MO billing wherein an SMS sent from the user's device triggers direct billing against the user's phone bill and wherein the network billing system 113 sends the collected fees to the payment gateway 227 based on the SMS transaction identification; (6) direct billing using premium short message service (SMS) MT billing wherein an SMS sent to the user's device triggers direct billing against the user's phone bill and wherein the network billing system 113 sends the collected fees to the payment gateway 227 based on the SMS transaction identification; (7) direct billing against a prepaid account associated with the one or more services; (8) direct billing to a user account registered with the services portal 221 (e.g., the Nokia Ovi Store) wherein the payment gateway 227 makes a billing request against the form of payment (e.g., credit card) registered with the services portal 221; and (9) direct billing against a third party payment provider (e.g., credit card payment provider). In exemplary embodiments, the user, the service provider, or both can configure the payment mechanism used by the services platform 111.

After collecting the appropriate payment, the payment gateway 227 sends the payment or, in some cases, verification of the payment to the services portal 221. The services portal 221 then interacts with the service activation system 229 (which may be implemented as a server) to initiate activation or modification of a service according to the service management request.

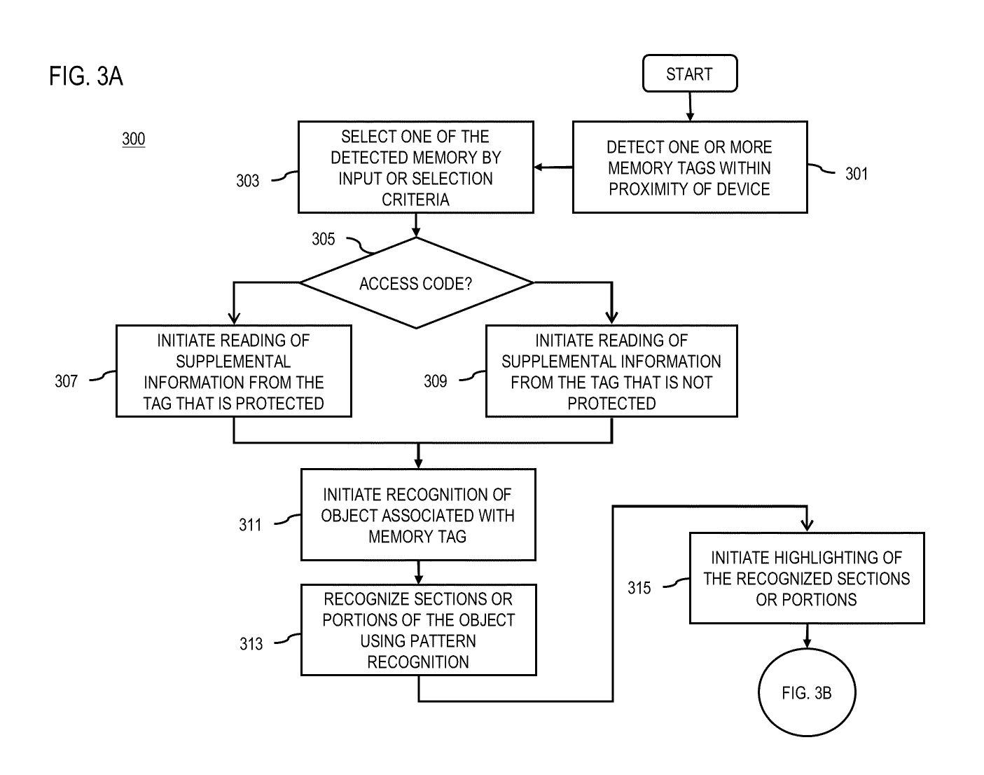

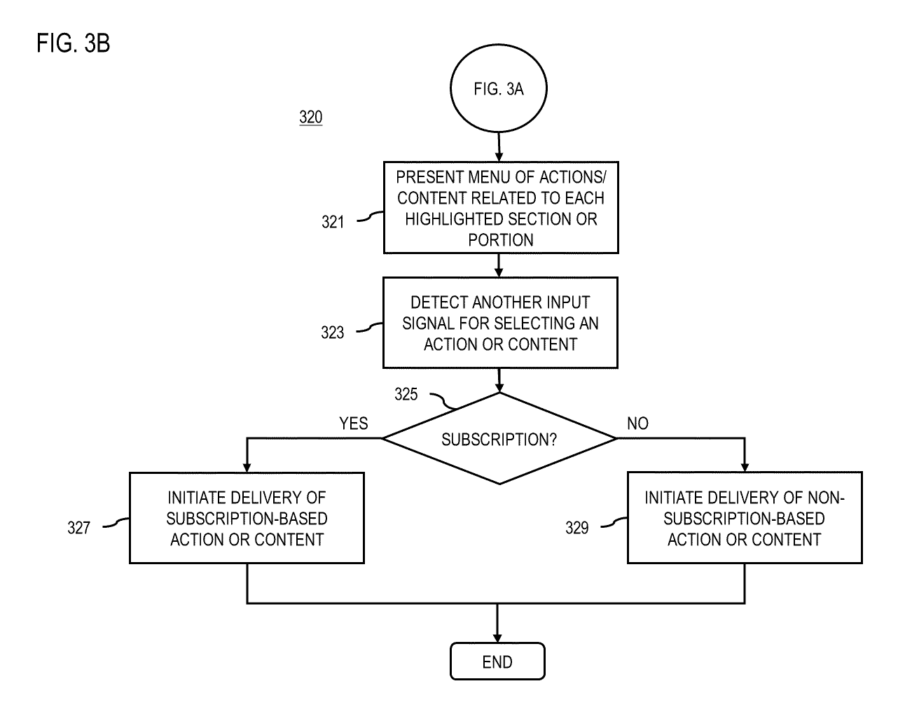

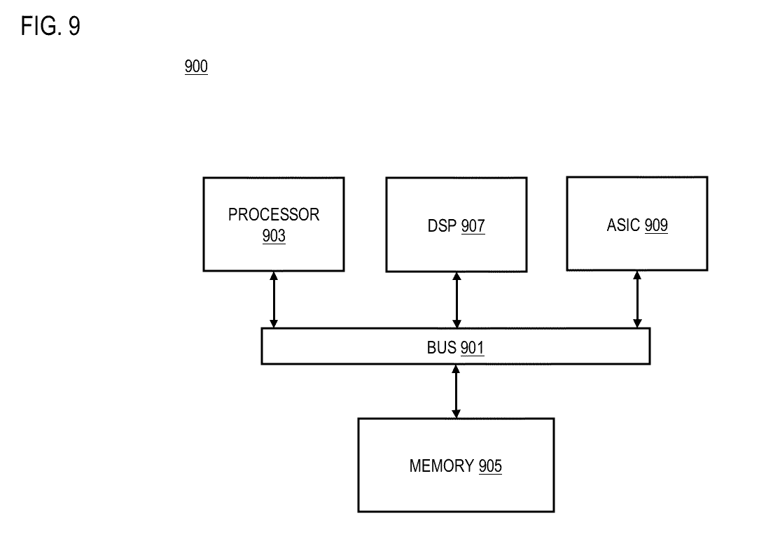

FIGS. 3A and 3B are flowcharts of a process for enhancing objects with tag-based content, according to one embodiment. The process 300 of FIG. 3A continues to the process 320 of FIG. 3B. In one embodiment, the tag-based content module 105 performs the process 300 and the process 320 and is implemented in, for instance, a chip set including a processor and a memory as shown FIG. 9. At 301, the tag-based content module 105 detects one or more memory tags 107 associated with one or more objects 109 within proximity of the UE 101. By way of example, the module 105 detects the one or more memory tags 107 using, for instance, the memory tag reader/writer 205. At the chip level, the module 105 detects the input by, for instance, receiving a signal via the memory tag reader/writer control module 203 that a memory tag 107 has been detected. This process is repeated to detect each memory tag 107 that is within proximity of the UE 101. In one embodiment, the proximity is limited by the range of the reader/writer 205. In certain cases, where the reader/writer 205 operates at sufficient range, the proximity for detection can be specified by the user, the services platform 111, an operator of the communication network 103, or a combination thereof.

After detecting the one or more memory tags 107, the module 105 selects one of the detected memory tags 107 by receiving an input signal from, for instance, the user indicating the selection or by applying selection criteria (at 303). The selection criteria direct the module 105 on how to automatically select a memory tag 107 from among the set of detected memory tags 107. For example, one criterion can specify that only a memory tag 107 associated with one of the user's subscribed services should be selected. In another example, a memory tag 107 associated with printed media such as a magazine that includes a serial identifier to indicate a particular volume of the magazine. A selection criterion can direct the module 105 to select a memory tag 107 associated with each volume of the magazine sequentially. It is contemplated that any selection criteria may be used by the module 105 for selecting a memory tag 107. On selection of a memory tag 107, the module 105 then determines whether the selected memory tag 107 requires an access code to read the contents of the tag 107 (at 305). If an access code is required, the module 105 provides the code to the memory tag 107 and initiates reading of the supplemental information that is protected from the memory tag 107 (at 307). If an access code is not required, the module 105 initiates reading of the unprotected supplemental information without needing to provide the access code (at 309). As previously discussed, the supplemental information includes recognition information in addition to information related to the object 109 such as an electronic representation of the object 109 (e.g., an electronic version of a magazine), one or more media files, one or more documents, one or more links to content, purchasing information, advertising information, an electronic catalog, or a combination thereof.

After reading the supplemental information from the memory tag 107, the module 105 initiates recognition of the object 109 associated with the selected memory tag 107. For example, to initiate optical pattern recognition, the module 105 activates the camera 211 of the UE 101 to begin capturing images of the object 109. By way of example, if the object 109 is printed media, the camera 211 captures images of pages of the printed media. As the user browses the printed media 109, the module 105 captures, for instance, either a video stream of images or periodic individual images of the printed media (at 311). As the object 109 is recognized, the module 105 performs, for instance, pattern recognition, audio recognition, and/or voice recognition to recognize one or more sections or portions of the object 109 based on the recognition information obtained from the supplemental information (at 313). The recognition information, for instance, may contain patterns, audio clips, or voices against which the module 105 will match the object 109. As a section or portion of the object 109 (e.g., a specific page of an object 109 that is printed media) is recognized, the module 105 initiates highlighting of the recognized sections or portions (at 315). For example, depending on the nature of the object, the highlighting may be performed on a visual display (e.g., a captured image of printed media), audio speaker (e.g., audio or voice alert), a vibration mechanism (e.g., haptic feedback), or a combination thereof. The process 300 continues in the process 320 of FIG. 3B.

As shown in FIG. 3B, the module 105 presents a menu of actions and/or content related to each highlighted recognized section for selection (at 321). The specific actions and/or content associated with each action is specified in the supplemental information read from the memory tag 107 and are, for instance, dependent on the subject of the highlighted section. For example, if the highlighted section depicts an item available for sale, the module 105 may present a menu with options to (1) view more information about the item, (2) purchase the item, (3) view a video of the item, and (4) search the Internet for information about the item. If the highlighted item is a news article, the menu may present options to (1) view links to related articles, (2) see additional articles by the same author, (3) search the Internet for similar articles, and (4) send the article to friends. In one embodiment, the actions available include: selecting a local topical view of the object 109 on the mobile device, initiating a purchase, initiating a payment, transferring data from the memory tag 107, writing a comment (e.g., a general comment or a specific comment regarding the object 109) to the memory tag 107, updating the supplemental information stored in the memory tag 107, initiating an Internet query, initiating presentation of a media file, checking availability of a product form a vendor, initiating the transfer of media to other media devices, creating a reminder for a delayed action, initiating an application (e.g., a web browser, word processor, media player), or a combination thereof. The module 105 then waits to detect another input signal for selecting one or more of the actions (at 323). In some embodiments, the result of the selected action depends on a subscription status associated with the user of the UE 101. In other words, the result received is different for subscribers and non-subscribers. Accordingly, the module determines whether the user of the UE 101 has a subscription to the requested action or content (at 325). If the user has a subscription, the module 105 initiates delivery of subscription-based action or content (at 327). If the user does not have a subscription, the module 105 initiates delivery of non-subscription-based action or content (at 329). In addition or alternatively, it is contemplated that the module 105 may use the subscription status of the user to determine whether the user has the access code to read information from the memory tag 107 as described at 303 of the process 300 of FIG. 3A. In this way, if the user's mobile device will not be able to read a protected memory tag 107 unless the user has a valid subscription.

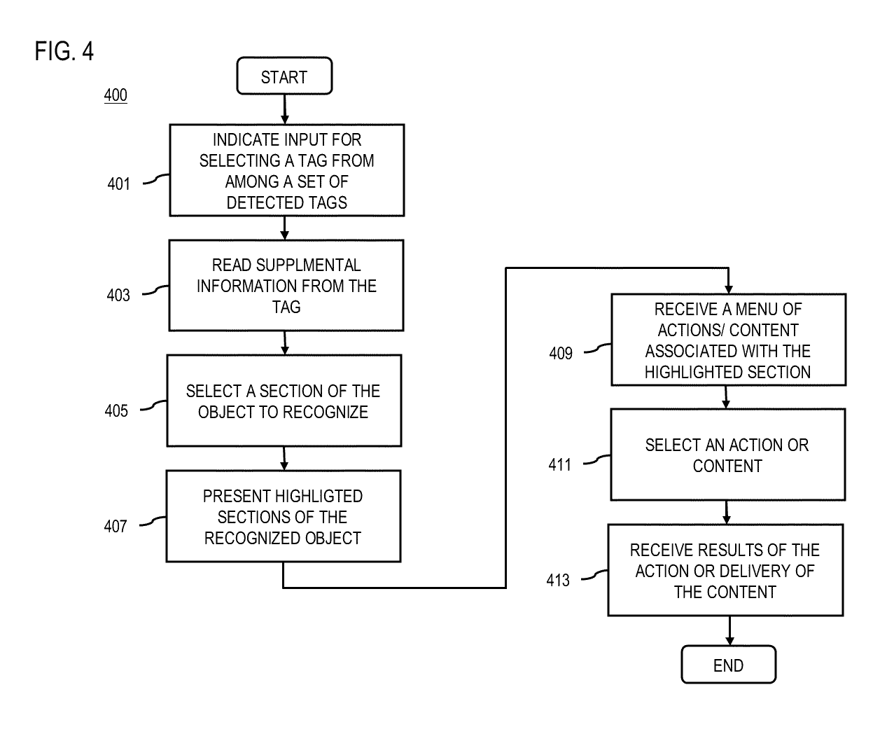

FIG. 4 is a flowchart of a process for accessing tag-based content using a memory tag associated with an object, according to one embodiment. As discussed previously, exemplary embodiments include the tag-based content module 105 within the UE 101 (e.g., hardware such as a wireless handset, laptop computer, etc.). The incorporation of the module 105 within the UE 101 extends the functions of the module 105 to the communication network 103 in which the UE 101 operates. Additionally, certain embodiments configure the UE 101 to include components (e.g., a memory tag reader 205, a camera 211, wireless transmitter (not shown)) not included with the module 105. Consequently, the UE 101, for example, is capable of directly reading the memory tag 107, recognizing the object 109 (e.g., capturing images of the object 109 for optical recognition, and capturing audio samples of the object 109 for audio or voice recognition), and transmitting messages over the communication network 103.

Process 400 begins with the UE 101 indicating a user input for selecting a memory tag 107 from among a set of memory tags 107 detected within proximity of the UE 101 (at 401). In certain embodiments, the user input is indicated by tapping a user equipment one or more times on or near the memory tag 107, by activating one or more buttons or menu options on the UE 101 itself, by using the UE 101 to read the memory tag 107, or by a combination thereof. It is contemplated that the user, the service provider, or both may configure the number of taps, buttons, or menu options to indicate a selection. The UE 101a then reads the supplemental information contained in the memory tag 107 using, for instance, an NFC reader, RFID reader, contactless card reader, or any combination thereof (at 403). As described previously, the supplemental information is stored in, for instance, the tag information database 207 for later use.

Next, the UE 101 selects the sections or portions of the object 109 to recognize. For example, the UE 101 performs optical recognition by directing the camera 211 of the UE 101 to the desired selection or portion of the object 109 (at 405). Pointing or directing the camera 211 to a particular section or portion of the object 109, for instance, automatically initiates recognition and highlighting of the object 109 as described with respect to FIGS. 3A and 3B. For audio or voice recognition, the UE 101 can activate a microphone in the UE 101 to capture audio samples of the object 109. The UE 101 then presents the highlighted sections or portions of the object 109 for selection (at 407). The presentation also includes a menu of actions and/or content associated with the highlighted section (at 409). Next, the UE 101 indicates selection of one of the presented actions or content (at 411). In one embodiment, the UE 101 includes the ability to detect movement, and the selection is initiated by movement of the UE 101 in a particular direction or in a particular pattern or gesture. For example, each direction of movement, pattern, or gesture is associated with an action or content. More specifically, moving the UE 101 in a forward direction may initiate an action to view additional information. Similarly, moving the UE 101 in a circular gesture may initiate an action to search the Internet for related information. The specific direction or pattern of movement is specified in, for instance, the supplemental information read from the memory tag 107. In addition or alternatively (e.g., when the UE 101 does not have the capability to detect movement), a menu selection may be initiated by pressing a key or key combination, touching a portion of the screen, moving a cursor, or similar input. After making the selection, the UE 101 receives the results of the action of delivery of the content (at 413). As discussed previously, in one embodiment, the selected action may include writing to the memory tag 107 to store user comments and/or to update the supplemental information stored in the memory tag 107.

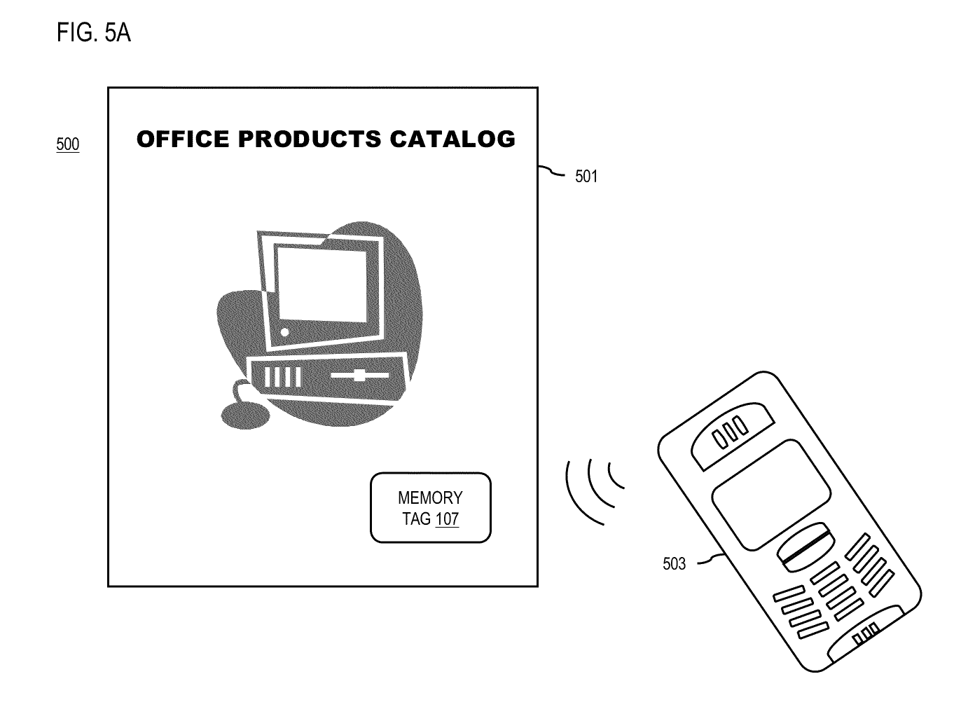

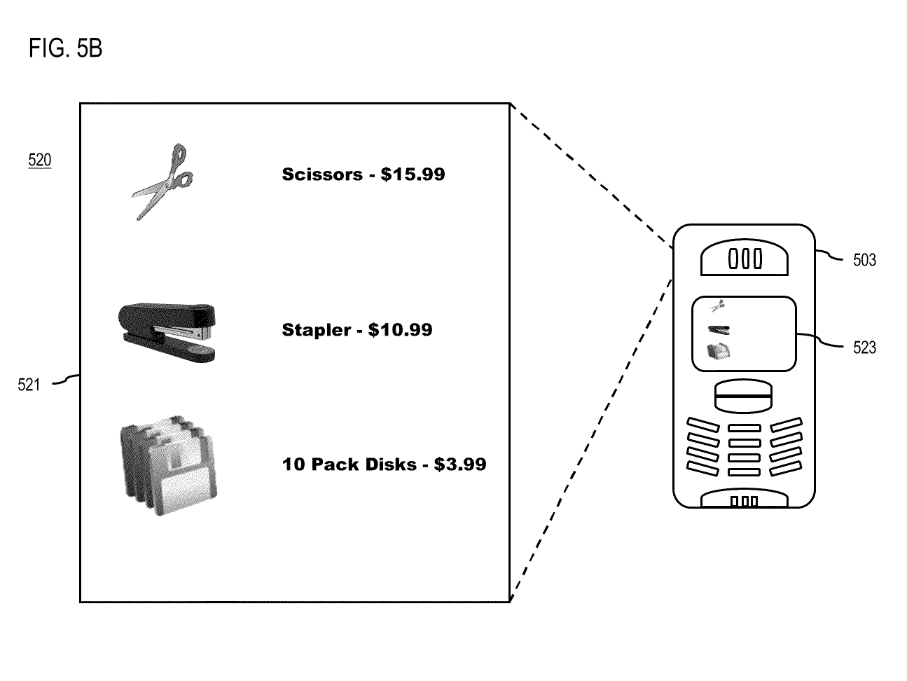

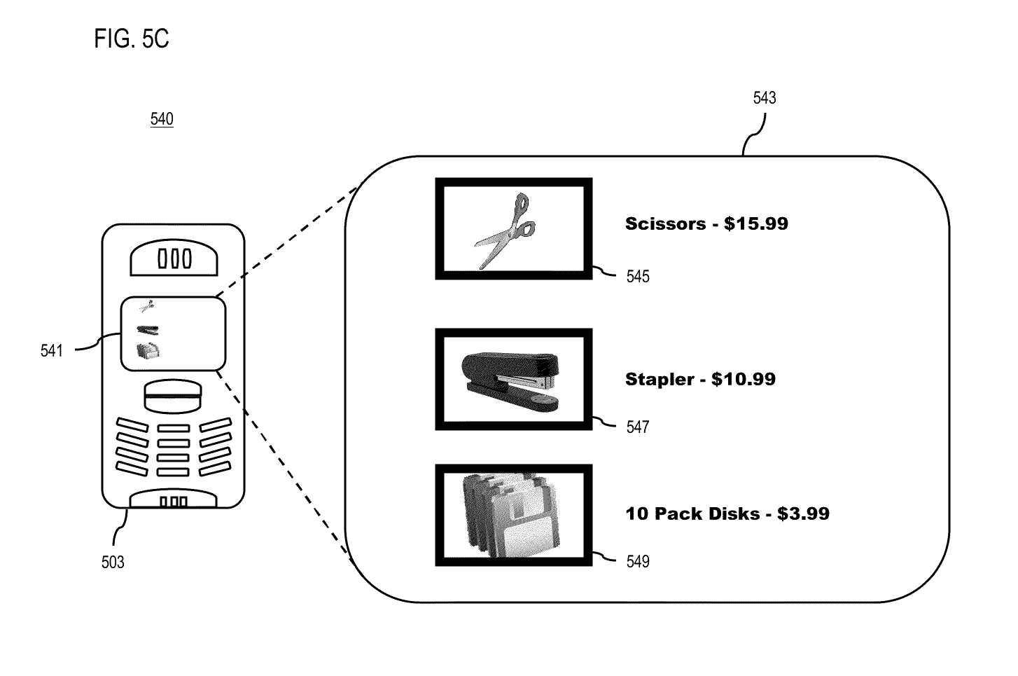

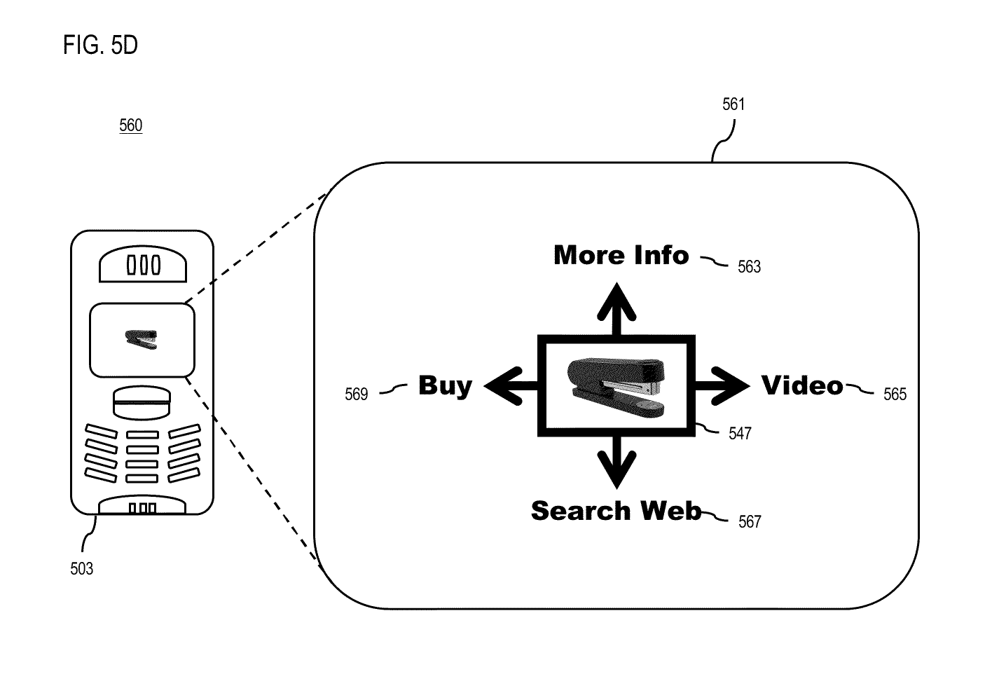

FIGS. 5A-5D are diagrams of user interfaces utilized in the processes of FIGS. 3A-3B and FIG. 4, according to various embodiments. FIG. 5A is a diagram of an example in which the object 109 is printed media (e.g., an office products catalog 501) including an associated memory tag 107, according to one embodiment. In this example, the memory tag 107 is affixed to the front cover of the office products catalog 501. The memory tag 107 includes, for instance, supplemental information on the products contained with the catalog including ordering information, links to reviews, links to availability checks, etc. The mobile device 503 is includes the tag-based content module 105 and is equipped with a memory tag reader 205 and a camera 211. To select the memory tag 107 and initiate the process for enhancing the office products catalog with tag-based content, the mobile device 503 is brought within proximity of or is tapped on the memory tag 107. On selection, the supplemental information is downloaded from the memory tag 107 to the mobile device 503.

FIG. 5B is a diagram of a catalog page 521 within the office products catalog 501, according to one embodiment. As shown, the mobile device 503 has already read the supplemental information related to the catalog 501 from the memory tag 107. Accordingly, the camera 211 of the mobile device 503 has been activated to capture an image of the catalog page 521. The catalog page 521 depicts various office products and has been captured on the mobile device as display 523.

FIG. 5C is a diagram of a captured image 541 of the catalog page 521 that has been processed for image recognition, according to one embodiment. As shown, display 543 is an enlargement of the captured image 541. The mobile device 503 has recognized the three items (e.g., scissors 545, stapler 547, and disks 549) presented in the display 543. In this embodiment, the mobile device 503 has highlighted each of the recognized items by placing a rectangle around each item. As described with respect to FIG. 4, the user of the mobile device 503 may select one of the highlighted items to obtain a menu of actions or content related to the item.

FIG. 5D is a diagram of a selected recognized item, according to one embodiment. In this example, the user of the mobile device 503 has selected the stapler 547 (e.g., a recognized item as shown in FIG. 5C). Accordingly, the display 561 presents the selected stapler 547 along with four actions or content associated with the stapler 547. The display 561 presents the four available commands along with the direction to move the mobile device 503 to initiate the command. For example, to initiate the action 563 to obtain more information about the stapler, the mobile device 503 can be moved in the forward direction; to initiate delivery of the video content 565 depicting the stapler 547, the mobile device can be moved in the right direction; to initiate the action to search the web for information about the stapler 547, the mobile device 503 can be moved in the backward direction; and to initiate the action 569 to buy the stapler 547, the mobile device 503 can be moved in the left direction. If the display 561 is touch-screen capable, the user may also indicate a menu choice by touching the area of the display 561 corresponding to the choice. In addition or alternatively, the user may indicate a menu choice by using a direction pad, joystick, keyboard, or other similar input device on the UE 101.

Referring back to FIG. 1, the system 100, in certain embodiments, provides a mechanism to retrieve content from a memory tag 107 and to update that content using up-to-date information available over the communication network 103 through, e.g., the services platform 111. More specifically, the system 100 enables the UE 101 to be able to receive (e.g., read) and transmit (e.g., write) up-to-date information or content to a memory tag by: (1) detecting a user profile for communication with a memory tag 107; (2) enabling a process for selecting content stored in the memory tag 107; (3) initiating content billing through the network billing system 113 via, for instance, short messaging service (SMS) and synchronizing content updates to the memory tag 107 using, for instance, a local data feed or Internet download; and (4) checking for updates from the local community of other devices and whether a requested content update is available from the local community.

By way of example, when configured to update memory tag 107 content, the system 100 may include one or more memory tags 107 with updatable content. In one embodiment, content is updated with the UE 101 is near a memory tag 107 that is located along a route on which the UE 101 is travelling. The memory tag 107 may be associated, attached, or installed on any available object including other devices. When installed in a device (e.g., a UE 101), the memory tag 107 is called, for instance, an embedded tag (etag). In another embodiment, updatable memory tags 107 operate in a Universal Local Storage (ULS) system wherein content is written to a service-specific memory tag 107 at one location and delivered at service point (e.g., corresponding to another memory tag 107) in the ULS system. In yet another embodiment, the contents of a memory tag 107 may be updated locally by the tag 107 itself when a data connection is available.

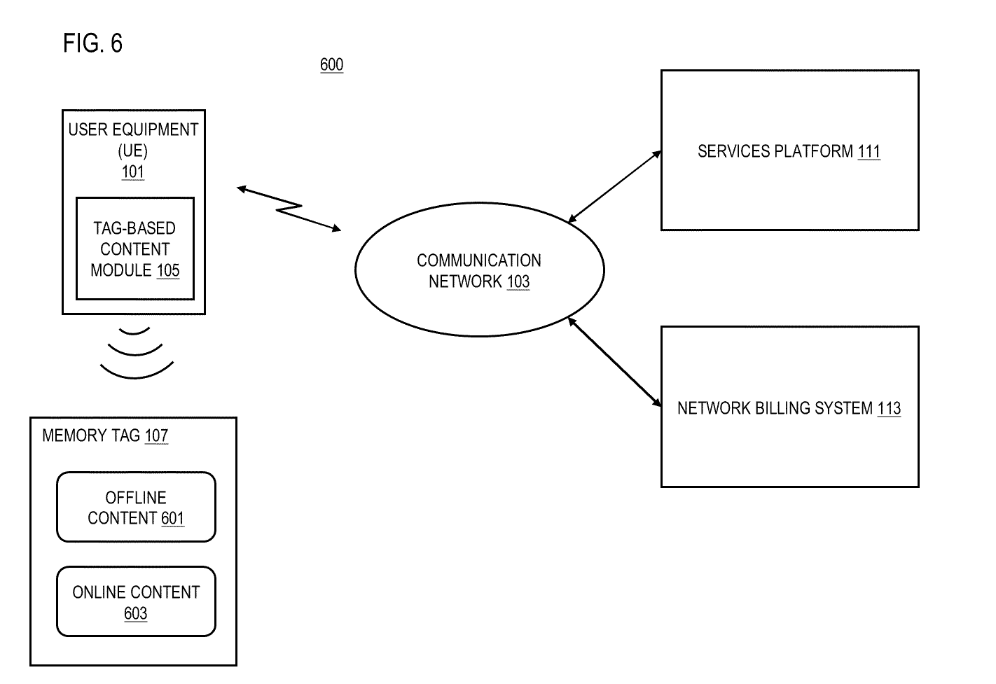

FIG. 6 is a diagram of communication system capable of supporting updatable memory tags, according to one embodiment. As shown, the system 600 includes similar components as discussed with respect to the system 100 (e.g., a UE 101, communication network 103, tag-based content module 105, memory tag 107, services platform 111, and network billing system 113). The primary difference is that, in the embodiment of FIG. 6, the memory tag 107 (e.g., a hybrid tag) includes both offline content 601 and online content 603. Offline content 601 includes content that is stored statically in the memory tag 107. In other words the offline content 601 is not updatable and can include information such as an identifier associated with the memory tag 107 or other content that does not change. Online content is content that is updatable within the memory 107. This update may be performed by the tag 107 itself, by the UE 101, by the service platform 111, or other like component of the system 600.

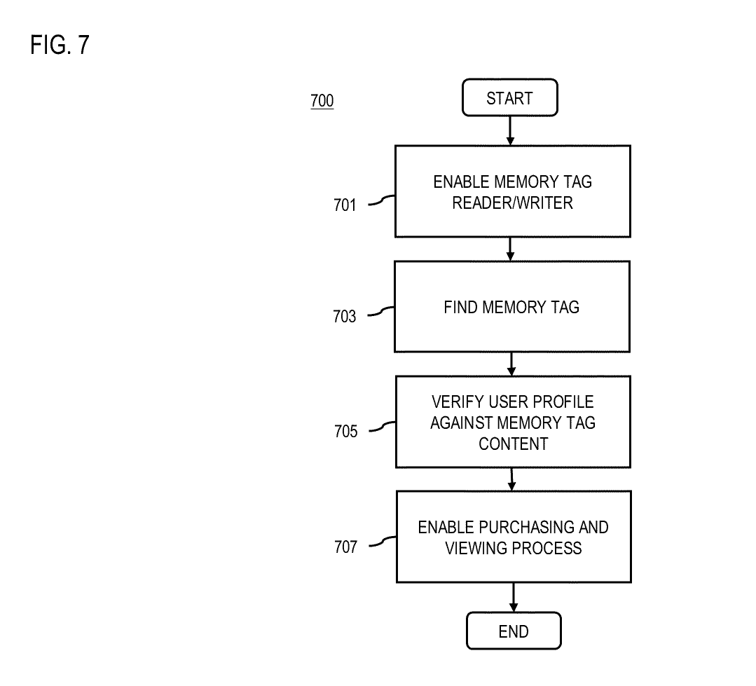

FIG. 7 is a flowchart of a process for detecting and verifying setup of an updatable memory tag, according to one embodiment. In one embodiment, the tag-based content module 105 performs the process 700 and is implemented in, for instance, a chip set including a process and a memory as shown in FIG. 9. At 701, the tag-based content module 105 enables the memory tag reader/writer 205 to begin searching for and detecting one or more memory tags 107 within proximity of the reader/writer 205. For example, the module 105 directs the reader/writer 205 to activate a continuous wave to provide, for instance, a clock signal and wireless power to nearby memory tags 107. The module 105 then finds the memory tags (e.g., using ultra-wideband (UWB)) (at 703). On finding the memory tag or tags 107, the module 105 initiates reading the memory tag 107 to verify an associated user profile and content purchasing classes (e.g., premium or basic shopper) as well as the memory tag identification and other service identifiers (e.g., Ovi Store) (at 705). By way of example, the user profile may be stored on the UE 101, on the services platform 111, or on another component of the communication network 103. After verification, the module 105 enables the UE 101 to initiate purchasing and viewing of items described or presented in the memory tag 107 (at 707). By way of example, enabling the UE 101 to purchase or view content includes setting content billing arrangements (e.g., payment via short messaging service, direct billing by service provider, billing via a web store, etc.).

The following describe several use case scenarios involving the memory tag 107.

In one use case scenario, a newsstand kiosk sells magazines embedded with one or more memory tags 107 including updatable content. The magazines are paper copies delivered with memory tags 107 that include both offline content 601 and online content 603. Each morning, the operator of the kiosk initiates and flashes updated contents to each of the magazines. The update process includes downloading updated content from a data service provided the publisher of each magazine that the kiosk sells. The update identifies the magazines with available updates by reading an identifier from the memory tag 107 that corresponds to each magazine. If the identifier matches, the update process writes the updated content to the memory tags 107 corresponding to magazine. Because the update process occurs wirelessly, the operator can update stacks of magazines at a time. This process is repeated for each magazine title that includes an update. In this way, consumers who buy magazines from the operator always have the latest available electronic content.

In another use case scenario, the UE 101 redirects a memory tag 107 read request to another available memory tag 107. In this example, the UE 101 approaches a public billboard containing and embedded memory tag 107 providing information on the latest concerts. However, the line in front of the billboard is long and the user of the UE 101 is unable to approach close enough to initiate reading the information from the memory tag 107. Instead, the UE 101 captures the location of the memory tag 107 attached to the billboard by, for instance, using a location-based service on the UE 101. The UE 101 can attach a keyword associated with the billboard to uniquely identify the memory tag 107. The UE 101 stores the read request along with the location and keyword into a memory tag 107 (e.g., an etag) associated with the UE 101. The UE 101 can remind the user to read the billboard's memory tag 107 at a more convenient time. In addition, the etag may be used to request information from neighboring devices that may have already read the information from the billboard's memory tag 107. For example, the UE 101 can identify all or a particular subset of neighboring etag equipped devices to determine whether any of the devices has read the information from the billboard. If yes, the device with the desired information can transfer the contents to the UE 101 via radio communications (e.g., Bluetooth, WiFi, cellular, etc.). In addition or alternatively, the UE 101 may read the information from the other device's etag in the same manner as reading content from a memory tag 107.

In another use case scenario, the updatable memory tag 107 can be used in a mailbox function when the UE 101 does not have data connection capabilities. For example, a user of the UE 101 receives a letter with an embedded memory tag 107 with reply post capabilities. The UE 101 reads the contents of the memory tag 107 and the user drafts a reply to the letter using the UE 101. On reading the memory tag, the UE 101 stores an identifier associated with the letter in its onboard etag. To transmit the letter, the user writes the contents of the reply and the identifier associated with the letter to a mailbox equipped with a corresponding memory tag 107. The postal delivery service can then read the contents of the mailbox memory tag 107 to a server for processing and delivery to the intended recipient of the reply. The letter may be delivered either electronically or physically according to preferences of the either the user or the intended recipient. In addition, the letter and the reply may be encrypted to protect privacy and sensitive information.

In yet another use case scenario, a service provider can set up a series of memory tags 107 positioned at various locations to provide a mechanism whereby updates via the memory tags 107 can follow the UE 101. In this way, the memory tag 107 that is closest to the UE 101 at the time of an update request can be used to provide the update information. In this example, there are two approaches for this update mechanism: (1) a content update is requested from one memory tag 107 via the UE 101 and the response is received by the UE 101 at another memory tag 107 (e.g., the next memory tag 107 that is closest to the UE 101 as the UE 101 moves within an area); and (2) the UE 101 downloads content at one memory tag 107 and receives an update at a second memory tag 107.

More specifically, an implementation of the first approach involves the UE 101 first connecting to a memory tag 107 and requesting a content update. The request includes, for instance, an identifier associated with an etag embedded in the UE 101. This etag uniquely identifies the UE 101 to the server responding to the update request. As the UE 101 moves and approaches a second memory tag 107, the UE 101 exchanges information (e.g., its etag identification) with the second memory tag 107. The second memory tag 107 initiates a query to the server and receives the content update requested by the UE 101. The UE 101 can then read the content update from the second memory tag 107.

In the second approach, the UE 101 reads the contents of a first memory tag 107 but is, for some reasons (e.g., no data connection), unable to obtain the latest updated content (e.g., the latest available downloads from a web store such as the Ovi Store) from the memory tag 107. The memory tag 107 initiates an update request on behalf of the UE 101. As described above, the request includes an identifier associated with an etag embedded in the UE 101 as well as an identifier associated with the content to be updated. As the UE 101 moves to within proximity of a second memory tag 107, the second memory tag 107 initiates a query to the server and receives the updated content. The UE 101 can then read the updated content from the second memory tag 107.

The processes described herein for enhancing objects with tag-based content may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

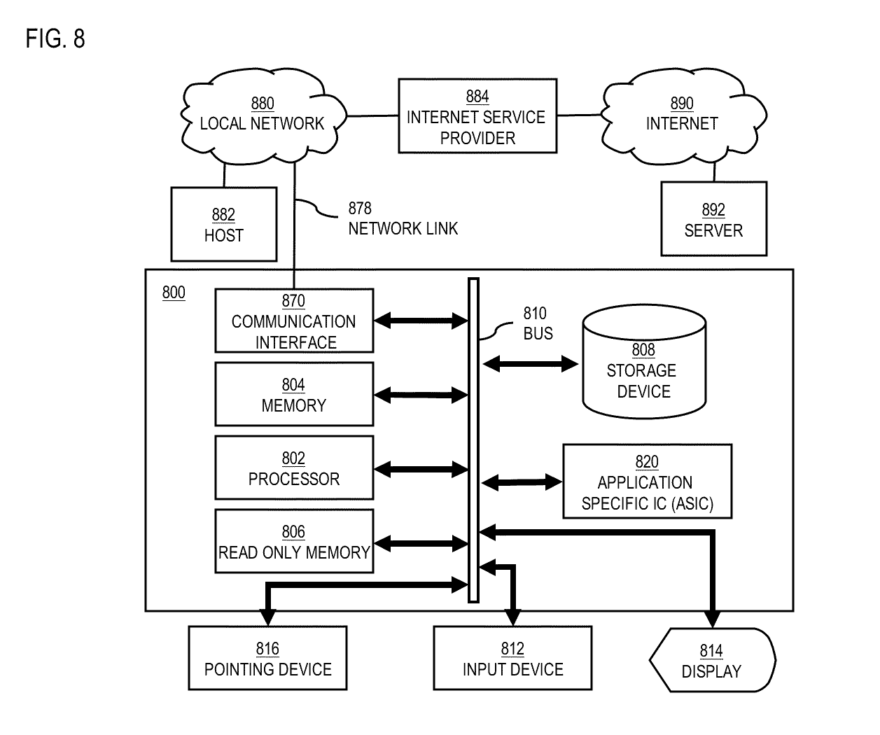

FIG. 8 illustrates a computer system 800 upon which an embodiment of the invention may be implemented. Computer system 800 is programmed (e.g., via computer program code or instructions) to enhance objects with tag-based content as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to enhance objects with tag-based content. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for enhancing objects with tag-based content. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for enhancing objects with tag-based content, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 614, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 103 for enhancing objects with tag-based content.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890. A computer called a server host 892 connected to the Internet hosts a process that provides a service in response to information received over the Internet. For example, server host 892 hosts a process that provides information representing video data for presentation at display 814.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set 900 upon which an embodiment of the invention may be implemented. Chip set 900 is programmed to enhance objects with tag-based content as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to enhance objects with tag-based content. The memory 905 also stores the data associated with or generated by the execution of the inventive steps.

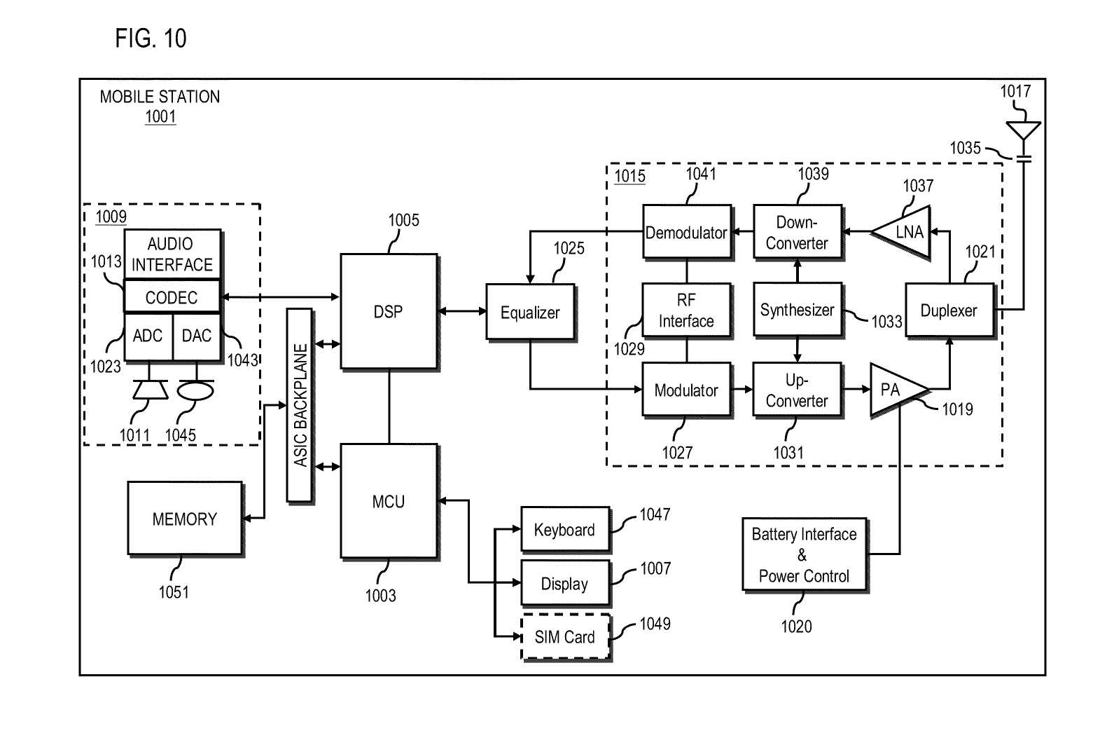

FIG. 10 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application, the term “circuitry” would also cover an implementation of merely a processor (or multiple processors) and its (or their) accompanying software/or firmware. The term “circuitry” would also cover, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that perform or support the steps of enhancing objects with tag-based content. The display 1007 includes a display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LIE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to enhance objects with tag-based content. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
detecting one or more memory tags associated with one or more objects within proximity of a mobile device, wherein the memory tag contains supplemental information related to the one or more objects;
selecting one of the detected memory tags by receiving an input signal or by applying one or more selection criteria; and
initiating reading of the supplemental information from the selected memory tag, wherein the supplemental information includes recognition information to associate the supplemental information with a specific section or portion of a respective one of the objects.

2. A method of claim 1, wherein the supplemental information further includes an electronic representation of the object, one or more media files, one or more documents, one or more links to content, purchasing information, advertising information, an electronic catalog, or a combination thereof.

3. A method of claim 1, further comprising:
initiating recognition of at least one section or portion of an object corresponding to the selected memory tag using a mobile device, wherein the recognition is based on the recognition information; and
initiating highlighting of one or more recognized sections or portions of the object corresponding to the selected memory tag.

4. A method of claim 3, further comprising:
presenting a menu of one or more actions or content related to each respective highlighted section or portion;
detecting another input signal for selecting one of the actions or content related to each respective highlighted section or portion; and
initiating the selected action or delivery of the selected content in response to the detection.

5. A method of claim 4, wherein the another input signal is initiated by a directional movement of the mobile device or by movement of the mobile device in a predefined pattern or gesture.

6. A method of claim 4, wherein the presented actions include selecting a local topical view on the mobile device, initiating a purchase, initiating a payment, transferring data from the memory tag, writing a comment to the memory tag, updating the supplemental information stored in the memory tag, initiating an Internet query, initiating presentation of a media file, checking availability of a product from a vendor, initiating the transfer of media to other media devices, creating a reminder for a delayed action, or a combination thereof.

7. A method of claim 4, wherein the object is printed media, and the memory tag is affixed to the printed media.

8. A method of claim 1, wherein the memory is a high memory capacity near field communication (NFC) tag, a wirelessly powered memory tag, or a combination thereof.

9. An apparatus comprising:
at least one processor; and
at least one memory including computer program code,
the at least one memory and the computer program code configured to, with the at least one processor, cause the apparatus to perform at least the following,
detect one or more memory tags associated with one or more objects within proximity of a mobile device, wherein the memory tag contains supplemental information related to the one or more objects,
select one of the detected memory tags by receiving an input signal or by applying one or more selection criteria, and
initiate reading of the supplemental information from the selected memory tag, wherein the supplemental information includes recognition information to associate the supplemental information with a specific section of a respective one of the objects.

10. An apparatus of claim 9, wherein the supplemental information further includes an representation of the object, one or more media files, one or more documents, one or more links to content, purchasing information, advertising information, an electronic catalog, or a combination thereof.

11. An apparatus of claim 9, wherein the apparatus is further caused to:
initiate recognition of at least one section or portion an object corresponding to the selected memory tag using a mobile device, wherein the recognition is based on the recognition information; and
initiate highlighting of one or more recognized sections or portions of the object corresponding to the selected memory tag.

12. An apparatus of claim 11, wherein the apparatus is further caused to:
present a menu of one or more actions or content related to each respective highlighted section or portion;
detect another input signal for selecting one of the actions or content related to each respective highlighted section or portion; and
initiate the selected action or delivery of the selected content in response to the detection.

13. An apparatus of claim 12, wherein the another input signal is initiated by a directional movement of the mobile device or by movement of the mobile device in a predefined pattern or gesture.

14. An apparatus of claim 12, wherein the actions include selecting a local topical view on the mobile device, initiating a purchase, initiating a payment, transferring data from the memory tag, initiating an Internet query, writing a comment to the memory tag, updating the supplemental information stored in the memory tag, initiating presentation of a media file, checking availability of a product from a vendor, initiating the transfer of media to other media devices, creating a reminder for a delayed action, or a combination thereof.

15. An apparatus of claim 12, wherein object is printed media, and the memory tag is affixed to the printed media.

16. An apparatus of claim 9, wherein the memory is a high memory capacity near field communication (NFC) tag, a wirelessly powered memory tag, or a combination thereof.

17. An apparatus of claim 9, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

18. A computer-readable storage medium carrying one or more sequences of one or more instructions which, when executed by one or more processors, cause an apparatus to at least perform the following steps:
detecting one or more memory tags associated with one or more objects within proximity of a mobile device, wherein the memory tag contains supplemental information related to the one or more objects;
selecting one of the detected memory tags by receiving an input signal or by applying one or more selection criteria;
initiating reading of the supplemental information from the selected memory tag, wherein the supplemental information includes recognition information to associate the supplemental information with a specific section or portion of a respective one of the objects, and wherein the supplemental information further includes an electronic representation of the object, one or more media files, one or more documents, one or more links to content, purchasing information, advertising information, an electronic catalog, or a combination thereof.

19. A computer readable storage medium of claim 18, wherein the apparatus is caused to further perform:
initiating recognition of at least one section or portion of an object corresponding to the selected memory tag using a mobile device, wherein the recognition is based on the recognition information;
initiating highlighting of one or more recognized sections or portion of the object corresponding to the selected memory tag;
presenting a menu of one or more actions or content related to each respective highlighted section or portion;
detecting another input signal for selecting one of the actions or content related to each respective highlighted section or portion; and
initiating the selected action or delivery of the selected content in response to the detection,
wherein the another input signal is initiated by a directional movement of the mobile device or by movement of the mobile device in a predefined pattern or gesture.

20. A computer readable storage medium of claim 18, wherein the memory is a high memory capacity near field communication (NFC) tag, a wirelessly powered memory tag, or a combination thereof.

21. An apparatus comprising:
a memory tag including at least a static memory for storing offline content related to an object associated with the memory tag and an updatable memory for storing online content related to the object associated with the memory tag,
wherein the memory tag includes a transponder.

22. An apparatus of claim 1, further comprising:
A processor configured to update the updatable memory with new online content related to the object associated with the memory tag based on a request initiated by the memory tag, a mobile device, a service platform, a service provider, a communication system component, or a combination thereof.

23. An apparatus of claim 1, wherein the transponder is near field communication (NFC) tag, radio frequency identification (RFID) tag, contactless card, or a combination thereof.
